(19) United States
(12) Patent Application Publication
(10) Pub. No.: US 2001/0048862 A1
(43) Pub. Date: Dec. 6, 2001

(54) Method and device for joining folded products

(76) Inventors: Alfred Baumann, Schwieberdingen (DE); Klaus Schumann, Leipzig (DE); Klaus Lampart, Stuttgart (DE)

Correspondence Address: DAVIDSON, DAVIDSON & KAPPEL, LLC, 485 Seventh Avenue, 14th Floor, New York, NY, 10018, US

(21) Appl. No.: 09/836,566

(22) Filed: Apr. 17, 2001

(30) Foreign Application Priority Data
Apr. 19, 2000 (DE) DE 100 19 273.4

(51) Int. Cl. B42C 11/04

(52) U.S. Cl. 412/4; 412/19

(57) ABSTRACT

A gatherer-stitcher used for gathering various folded sheets is additionally equipped with one or a plurality of devices for applying adhesive, so that the gathered sheets can be bonded to one another directly on the gatherer-stitcher.

### BACKGROUND OF THE INVENTION

The present invention is directed to a device for joining folded products gathered on a raceway such as a gatherer chain conveyor, in particular folded sheets or thread-sealed folded sheets.

Gatherer-stitchers are paper-processing machines which manufacture a product from a plurality of folded sheets, the individual folded sheets being so joined to one another that a finished product results. The manufactured end products are multi-page printed products, such as magazines, brochures, or the like. Gatherer-stitchers of this kind usually include one or more folded-sheet feeders, which feed the individual folded sheets to a raceway, upon which the various folded sheets are collected into groups to form the desired end product. The groups hanging on the raceway are usually fed to a stapling station having one or more stapling heads. At the stapling station, the folded products are joined at their spines by wire staples. Once stapled together, the groups of folded sheets are conveyed to a trimmer, which cuts the edges of the stapled products and then feeds them to a delivery unit.

The folded sheets, provided either laying or standing on their spines in the folded-sheet feeders, are separated, opened, and placed on the raceway. This process is repeated with each folded-sheet feeder until the desired number of folded products hangs one over another, as a group, on the raceway and is situated true-to-register thereon. The last feeder then feeds a folded cover sheet to the group. Alternatively, a sheet can be folded while being conveyed on the raceway by a so-called cover folder feeder. The cover is placed in this manner over the group of folded products.

To join the thus gathered folded products, the cover is conveyed, together with the remaining folded products, to a stapling station, where one or more staples are stuck through the spines of the folded products, [piercing the same], thereby joining the folded products, as well as the cover, to one another. A method of this kind is known, for example, from German Patent DE 197 38 929.

Although staples securely fasten folded products to one another, the need can arise to join the folded products to one another in some other way, and not by using wire staples. This is particularly the case when the end product to be manufactured is intended to be used for the most part by children or by small children, where eliminating the danger of injury is paramount. Coloring books made for children, as well as assembly or operating instructions for children's toys, which are stapled on the inside by wire staples, for example, can easily cause injury to children's hands.

### SUMMARY OF THE INVENTION

An object of the present invention is, therefore, to provide a device and a method which will make it possible to permanently join folded products to one another on a gatherer-stitcher and to, nevertheless, avoid the danger of injury by a wire stapling.

The present invention provides a device for joining folded products (20a, 20b) gathered on a gatherer-stitcher, in particular folded sheets or thread-sealed folded sheets, which are transported on a conveying device (10) of the gatherer-stitcher, hanging, with their spines (32) directed upwards, wherein the gatherer-stitcher has a station (24) for applying glue to the spines (32) of the folded products hanging on the gatherer-stitcher.

The present invention also provides a method for joining folded products (20a, 20b) gathered on a gatherer-stitcher, in particular folded sheets or thread-sealed folded sheets, at least one folded product (20a, 20b) being conveyed from a folded-sheet feeder of a raceway of a gatherer-stitcher, wherein adhesive is applied along the spine (32) of a folded product hanging on the raceway (10), and the folded product provided with adhesive is subsequently covered with an additional folded product (22, 20b).

It is generally a distinction of the device according to the present invention to provide at least one additional station at the gatherer-stitcher. The additional station makes it possible to apply adhesive or glue to the spine of a folded product situated at the top of a group of folded products, or to an individual folded product, thereby enabling a cover page to be placed thereon and to be permanently joined to the remaining folded product(s) without using wire staples in the process. It is especially advantageous in this context when the folded products, constituted as a group, are already joined to one another in some other fashion, without the cover. In particular, the folded products may be thread-sealed folded products that have been thermoplastically joined by a thread in a previous sequence of operation.

The device according to the present invention, therefore, has the advantage of facilitating the production of printed products, which are permanently joined to one another, the need being completely eliminated for wire staples which always hold the danger of injury. A further benefit is that wire staples no longer have to be removed, a step which requires considerable effort, so that the process of recycling the paper material is substantially simplified.

A further benefit of the device according to the present invention is derived from the fact that the gluing station can be installed as an additional element on already existing gatherer-stitchers, making it optional to either implement the classic stapling using wire staples and/or a stapleless joining of the folded products using the gluing station.

### BRIEF DESCRIPTION OF THE DRAWINGS

Further benefits and advantageous further refinements constitute the subject matter of the figures and of their descriptions in the following, the figures not being drawn true to scale the sake of clarity.

FIG. 1 shows the schematic representation of a gatherer-stitcher; and

FIG. 2 shows schematically, a device according to the present invention in the area of the gluing station.

### DETAILED DESCRIPTION

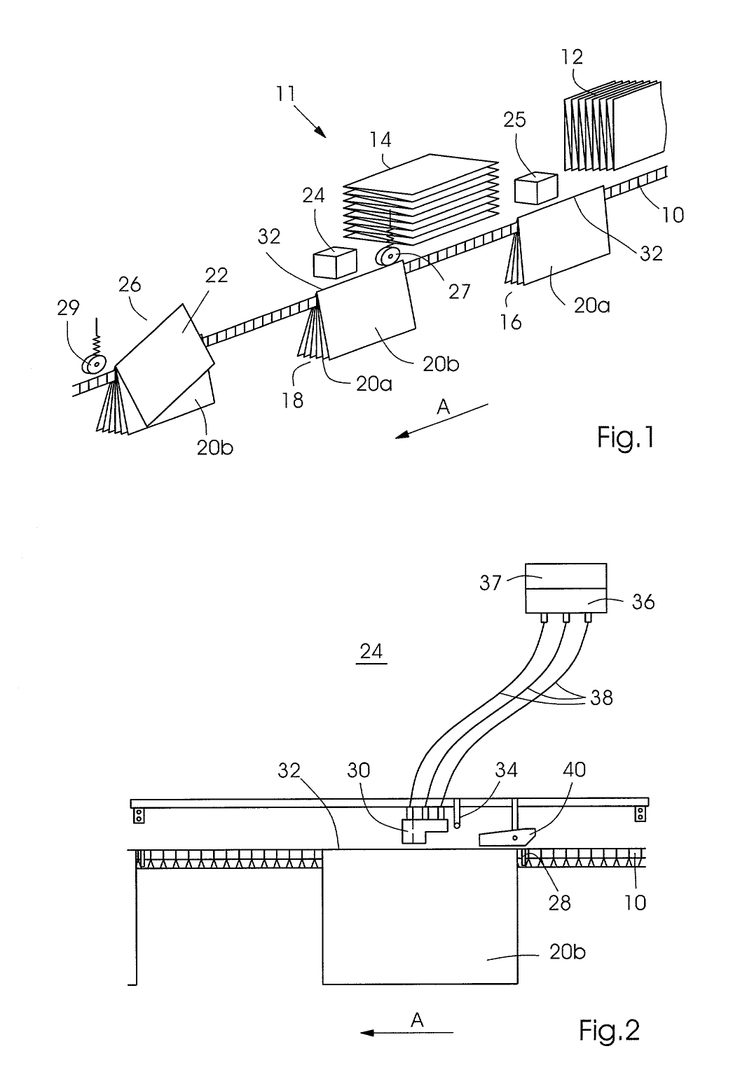

FIG. 1 schematically illustrates a conveyor system of a gatherer-stitcher in accordance with the present invention, which includes a gluing station. This conveyor system is usually designed as a raceway 10. From stacks 12, 14 of folded products present in each of the folded-sheet feeders, individual folded products 20a, 20b are transported by a plurality of folded-sheet feeders (not shown for the sake of clarity in FIG. 1) onto raceway 10, on which they come to rest, hanging one over another. Groups of folded products 16, 18 are formed in this manner and are transported on the raceway in arrow direction A. As shown in FIG. 1, the stacks of folded products can be fed to the raceway as stacks 12 resting on their spine or as stacks 14 resting on their surfaces. Folded products 20a, 20b are, for example, folded sheets or signatures, or folded signatures or sheets that have been joined to one another in a previous work step. So-called thread-sealing comes under consideration, in particular, as a way to join the folded products beforehand.

Each group of signatures 16 is conveyed on raceway 10 in arrow direction A and, in the process, arrives at a device 25, which can be used to apply an adhesive, such as a glue, to spine 32 of topmost folded product 20a of a group 16. Once the adhesive is applied, the group is moved along in arrow direction A, and can be led to another station 11, where another folded product 20b is placed over topmost folded product 20a. A pressure roller 27 is used to permanently join folded product 20b to the remaining folded products, particularly to folded product 20a.

Optimally, a second gluing station 24 can be provided which is used at this point in similar fashion to apply glue to the now topmost folded product 20b. Group 18 is further transported along conveying route A to arrive at a further station 26.

Here, a cover page 22 is placed over group 18, on glue-covered spine 32 (FIG. 2) of signature 20b. Cover page 22 is then pressed by pressure roller 29.

Provided that all folded products of a group 16, 18 are already joined to one another, application of adhesive at station 24 enables one cover page to be completely joined to the remaining folded products, without having to staple the folded products using wire staples.

Once all the folded products, including cover page 22, are joined together, the thus completed, multipage printed product, for example a magazine, operating instructions, a coloring book or the like, can be conveyed to further handling or processing stations, such as to a trimming station.

Although the present invention manages completely without stapling to join the folded products, one can conceive of the gatherer-stitcher having a station for inserting staples, which can be used alternatively to glue application station 24, so that, depending on the end product to be produced, the gatherer-stitcher is able to produce folded products that are joined to one another by stapling or by bonding.

FIG. 2 schematically depicts a device in accordance with the present invention in the vicinity of gluing station 24. Topmost folded product 20b of group 18 is transported on a raceway 10 by underlying folded products 16 (FIG. 1) in transport direction A, the folded products being aligned by a transport finger 28 mounted on raceway 10. A glue application head 30 applies glue to the spine of topmost folded product 20b, while the raceway, together with the folded products, continues to move underneath glue application heads 30 in arrow direction A. A control unit 36, a gluing unit 37, and a sensor 34 control the quantity of adhesive and the instant of its application. For this purpose, glue application head 30 is connected to lines 38 and 38. Line 39 carries the adhesive, and lines 38 transmit the control pulses and supply the compressed air for the adhesive application. Sensor 34 detects the front edge of the folded product and transmits a signal via line 41 for further processing to control unit 36, which controls the length of the glue line to be applied and the interval in which no glue is applied. A vertically adjustable hold-down device 40 is provided for holding down folded product 20b during glue application.

Following the application of glue to spine 32, the group of folded products 18 (FIG. 1), as already described in FIG. 1, is conveyed to a station 26, where a cover is put on the adhesive to join all folded products to one another. It is, therefore, advantageous to provide the gluing station as the last station, immediately before the location where the cover is placed on the raceway.

Once the cover is placed on the adhesive, the glued product is preferably conveyed to a pressure-applying station 29, where cover 22 is pressed onto the remaining folded products 20a, 20b, 16. The pressure-applying station, preferably a spring-loaded forming roller, presses the folded sheets together in such a way that the adhesive join is fixed and a precision bonding results.

A further benefit is derived from the fact that the device according to the present invention can be used even when only one of the folded-sheet feeders, usually provided in a plurality, is equipped and is in operation, and when folded products, already joined to one another, are present in these folded-sheet feeders. These can be folded products that have been joined by thread-sealing, for example. As described, they are conveyed to the raceway. The adhesive is then applied to the spine of the interconnected folded products and, in a further process step, covered by a cover page and permanently joined by the adhesive to the thread-sealed folded products. In this manner, an end product can be produced, whose inside pages are joined together using the thread-sealing technique or other methods, and whose cover page is fastened by adhesive to the thread-sealed folded products. Therefore, from the outside, it is not evident what kind of joining method is used to make the individual folded products adhere to one another. Moreover, this end product has no pointed or sharp wire staples whatsoever, so that it also meets more stringent safety requirements.

Another advantageous specific embodiment of the device according to the present invention provides for multiple gluing stations 24, and optionally for multiple pressure-applying stations 27, for example, for one gluing station 24 to follow every or every few folded-sheet feeders. This multiplicity of gluing stations now makes it possible to apply a glue line to the spine of the folded product, once it is placed on the raceway, this glue line then being suited, in turn, to bond the next folded product to be placed, to the folded products already located on the raceway. Thus, an end product can be manufactured which is entirely composed of folded products that are joined to one another by glue.

All adhesives suited for joining folded products can be used, such as glue, in particular, however, dispersion glue, hotmelt glue, PUR (polyurethane reactive) adhesives or fugitive glue.

### Reference Symbol List

10 raceway

11 station

12, 14 stacks of folded products

16, 18 groups of folded products

20a, 20b folded products

22 cover page

24 gluing station

26 station

27 pressure-applying station

28 transport finger

29 pressure-applying station

30 glue-application head

32 spine

34 sensor

36 control unit

37 gluing device

38 lines

39 line

40 hold-down device

41 line

What is claimed is:

1. A gatherer-stitcher for joining folded products comprising:
a conveying device for conveying the printed products in a hanging fashion with printed product spines directed upwards,
a first station for applying adhesive to the spines of the folded products hanging on the conveying device, and
a second station for applying additional adhesive to the spines of the folded products hanging on the conveying device.

2. The gatherer-stitcher as recited in claim 1 wherein the folded products are folded sheets or thread-sealed folded sheets.

3. The gatherer-stitcher as recited in claim 1 wherein the first station for applying adhesive to the spines has a glue application head and a hold-down device.

4. The gatherer-stitcher as recited in claim 3 wherein the glue application head is connected to a control unit which controls at least one of a quantity of adhesive to be applied and the instant of application of the adhesive.

5. The gatherer-stitcher as recited in claim 1 wherein the first station is provided directly before a station for placing the cover on the folded products.

6. The gatherer-stitcher as recited in claim 1 further comprising a stapling station for stapling the folded products using wire staples.

7. The gatherer-stitcher as recited in claim 6 further comprising a control device selectively releasing the station for a gluing operation or for a stapling operation.

8. The gatherer-stitcher as recited in claim 1 wherein the first station is provided downstream from the each folded-sheet feeder.

9. The gatherer-stitcher as recited in claim 1 wherein the first and second stations are provided downstream from each folded-sheet feeder.

10. The gatherer-stitcher as recited in claim 1 wherein provision is made along the conveying device for sensors linked to a control device for applying the adhesive to the spine, thereby controlling application of the adhesive to the spine.

11. A method for joining folded products gathered on a gatherer-stitcher, at least one folded product being conveyed from a folded-sheet feeder of a raceway of the gatherer-stitcher, comprising the steps of:
applying adhesive along a spine of a folded product hanging on the raceway; and
subsequently covering the folded product provided with adhesive with an additional folded product.

12. The method as recited in claim 11 wherein the adhesive is applied by a gluing station having a glue application head and a hold-down device.

13. The method as recited in claim 12 wherein the glue application head is connected to a control device controlling at least one of a quantity of adhesive to be applied and an instant of application of the adhesive.

14. The method as recited in claim 11 wherein, immediately before the additional folded product is placed, the applying step occurs.

15. The method as recited in claim 11 wherein the glue is applied to a thread-sealed folded product.

16. The method as recited in claim 11 wherein a multiplicity of folded products is fed with the assistance of a multiplicity of folded-sheet feeders to the raceway, such that these folded products hang one over another and, in each case, subsequent to the feeding of a folded product onto the raceway, glue is applied to the spine of the folded product just fed.

17. A multi-page printed product comprising a cover and a plurality of pages situated inside the cover, wherein the pages situated inside the cover are joined to one another by thread-sealing, and the cover, together with the inside pages that are joined to one another, is joined by an adhesive at the edge of the inside pages.

18. A multi-page printed product comprising a cover and a plurality of pages situated inside the cover, wherein the innermost folded sheet or folded product which is thread-sealed or joined using other methods is joined by fugitive glue for lifting off the same, to the printed product.

19. The method as recited in claim 11 wherein subsequent to the adhesive application and the conveying of the cover or of another folded product, a pressure-applying station is provided for fixing the adhesives to the cover or to another folded product.

20. The method as recited in claim 19 wherein the pressure applying device is a spring-loaded roller.

21. The method as recited in claim 19 wherein multiple pressure-applying stations are provided.

22. The method as recited in claim 11 wherein lateral gluing heads are also provided for lateral application of glue to the folded product.
